(19) United States
(12) Patent Application Publication
(10) Pub. No.: US 2011/0151388 A1
(43) Pub. Date: Jun. 23, 2011

(54) Adjustable Candle Holder

(76) Inventor: Keisha Moreen Knight, Beltsville, MD (US)

(21) Appl. No.: 12/642,854

(22) Filed: Dec. 20, 2009

(51) Int. Cl. F21V 35/00

(52) U.S. Cl. 431/289

(57) ABSTRACT

an adjustable candle holder comprising of a mechanical, fire-proof, glass foundation which will cooperatively allow the integral internal chamber to traverse longitudinally from the base of the candle while protecting the stem.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

Candles have been in use since biblical times as a primary source of light. Although electricity has replaced candles for primary lighting, they continue to grow in popularity and use. They are used in celebrations, romance, ceremonies, and homes. Because of this rise in popularity, the number of fires caused by candles has increased accordingly. They can add beauty and atmosphere to the decor of any home, but only if they are used properly and safely. It is very easy for an unsupervised candle to turn a happy home into a major disaster. To this end, the usefulness of candle holders is unquestionable. The primary function of candle holders is to hold candles and allow them to burn safely and to prevent wax from dripping on the floor or elsewhere. Candle holders are a perfect decorative item and are frequently used in homes, restaurants, and the like. They evoke a general mood of relaxation, warmth, and romance. The endless availability of styles and designs of candle holders make them ideal show-pieces.

As a result, the purpose of this invention is to improve the current structure of candle holders. The improvement will keep the candle steady and straight and simplify its use by allowing for safe and efficient candle burning. Contemporary candle holders do not allow the user to conceal the stem of the lit candle in a fire proof container for safety—the stem of the lit candle is exposed. It is impossible to find a candle holder that will adjust to the length of the candle as it is needed while concealing the stem of the lit candle. This presents a fire hazard when the candles are in use. A research of prior art revealed adjustable candle holders that are designed to hold candles in various diameters and perpendicular positions but do not allow vertical adjustability. Further, although research did not uncover any patents directly related to this instant invention, the U.S. Pat. No. 3,556,704 disclosed an adjustable candle holder adapted to receive a candle of varying diameters with mounting means. It also utilizes mounting means that provide vertical selective adjustments.

### BRIEF SUMMARY OF THE INVENTION

The goal of this instant invention is to improve the current structure of candle holders by reducing accidents caused by candle misuse each year. Specifically, this instant invention includes an adjustable candle holder comprising of a mechanical, fire-proof, glass foundation which will cooperatively allow the integral internal chamber to traverse longitudinally from the base. It is assembled and dimensioned to hold candles perpendicularly within the internal cavity. The adjustable candle holder is comprised of a self-controlling mechanism aligned and affixed to said candle retaining assembly. The chamber is comprised of an integral adjustable inner free-flowing apparatus and adaptable gripper slots on said candle-retaining assembly. The self-controlling panels will permit the stem of the candle to remain concealed or exposed as the candle burns. The candle holder also allows for easy replacement of the candle by inserting a new candle in the opening of the top of the holder into the base of the holder. The candle holder also allows for easy replacement of the candle by inserting a new candle in the opening of the top of the holder into the base of the holder. Unlike prior adjustable candle holders, a major advantage of this candle holder is that as the candle burns, the inner tray of the candle holder can be adjusted to push the candle up by using the self-controlling panel and still permit the stem of the candle to remain concealed as the candle burns.

### BRIEF DESCRIPTION OF THE SEVERAL VIEWS OF THE DRAWING

FIG. 1 is a comprehensive plain view of the adjustable candle holder.

### DETAILED DESCRIPTION OF THE INVENTION

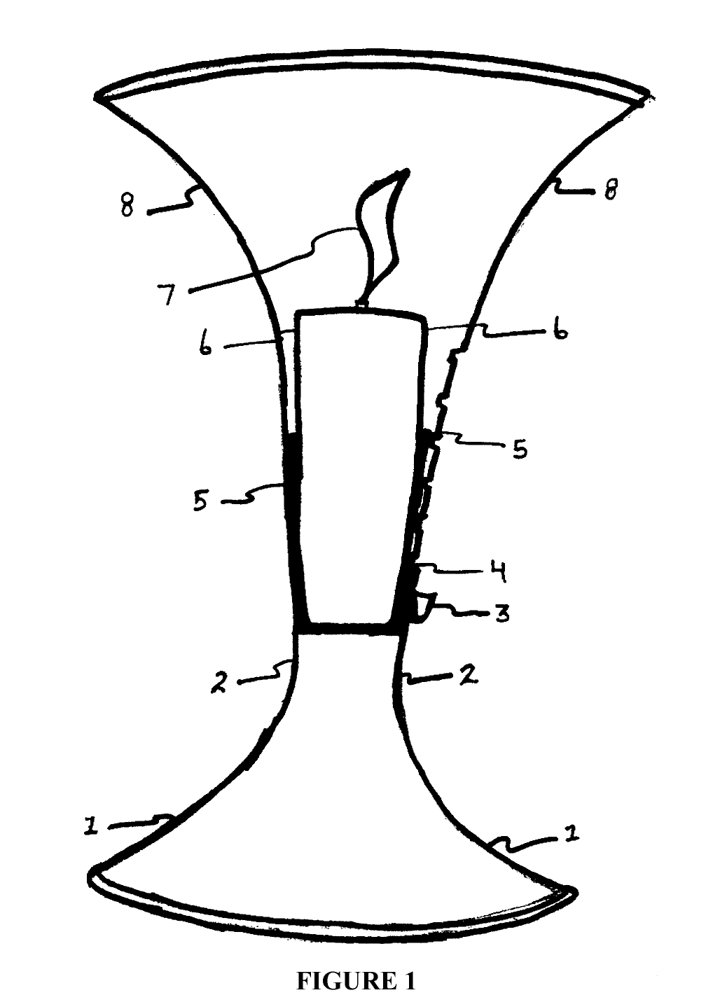

The embodiment of this instant invention as detailed in FIG. 1 of the drawing includes an adjustable candle holder comprising of a mechanical, fire-proof, glass foundation (2) which will cooperatively allow the integral internal chamber (5) to traverse longitudinally from the base (1). It is assembled and dimensioned to hold candles perpendicularly within the internal cavity (5). The adjustable candle holder as specified is comprised of a self-controlling mechanism (3) aligned and affixed to said candle retaining assembly. The chamber is comprised of an integral adjustable inner free-flowing apparatus (5) and adaptable gripper slots (4) on said candle-retaining assembly. The upper section of the instant adjustable candle holder is dimensioned with an upper surface (8) which lengthens outwardly to protect the candle. The self-controlling panel (3) will permit the stem of the candle to remain concealed or exposed as the candle burns (6 and 7). The candle holder also allows for easy replacement of the candle by inserting a new candle in the opening of the top of the holder into the base of the holder.

1. An adjustable candle holder comprising of a mechanical, fire-proof, glass foundation which will cooperatively allow the integral internal chamber to project and traverse longitudinally from the base;
dimensioned to hold candles perpendicularly within the internal cavity;
assembled with a multiplicity of shifting parts.

2. The adjustable candle holder as specified in claim 1 is comprised of a self-controlling mechanism aligned and affixed to said candle retaining assembly.

3. The adjustable candle holder as specified in claim 1 is comprised of an integral adjustable inner free-flowing apparatus.

4. The adjustable candle holder as specified in claims 1 and 2 is comprised of adaptable gripper slots on said candle-retaining assembly.

5. The upper section of the instant adjustable candle holder as specified in claim 1 is dimensioned with an upper surface which lengthens outwardly to protect the candle holder.
